(19) United States
(12) Patent Application Publication
(10) Pub. No.: US 2026/0016030 A1
(43) Pub. Date: Jan. 15, 2026

(54) FASTENING ELEMENT FOR A COMPONENT AND METHOD FOR PRODUCING A PANEL ELEMENT AND A COMPONENT

(71) Applicant: Thor Tech, Inc., Elkhart, IN (US)

(72) Inventors: Michael Schroll, Kisslegg (DE); Christian Borgenheimer, Warthausen (DE); Florian Dienstbier, Bad Waldsee (DE)

(21) Appl. No.: 19/259,193

(22) Filed: Jul. 3, 2025

(30) Foreign Application Priority Data
Jul. 10, 2024 (DE) 10 2024 119 654.8

(51) Int. Cl. F16B 2/04; F16B 5/00

(52) U.S. Cl. CPC F16B 2/04; F16B 5/0088; F16B 2200/403

(57) ABSTRACT

The invention relates to a fastening element for a component, in particular for integration into a vehicle or a piece of furniture, a panel element with such a fastening element, a component with such a fastening element, a vehicle with such a panel element and/or component, and a method for producing a panel element and a component, wherein the fastening element comprises a partially cylindrical body, a projection extending from the body in the radial direction, at least one first spreading element, which is designed to spread outwards radially from the body, and a fastening means guide, formed in the body, which is designed to receive a fastening means therein and guide it through a passage which is arranged in the body and is connected to the fastening means guide.

### CROSS-REFERENCE TO RELATED APPLICATIONS

This application claims priority to German application No. 10 2024 119 654.8 filed Jul. 10, 2024, the disclosure of which is hereby incorporated by reference in its entirety.

### FIELD

The invention relates to a fastening element for a component, in particular for integration into a vehicle or a piece of furniture, a panel element with such a fastening element, a component with such a fastening element, a vehicle with such a panel element and/or component, and methods for producing a panel element and a component.

### BACKGROUND

Conventional fastening elements such as so-called cup connectors, particularly in furniture construction, usually require additional components with which they can engage, such as a profile or a profile rail. In particular, two cup connectors are usually used, each of which engages in a profile rail. In addition, conventional cup connectors do not always ensure perpendicular guidance of a fastening means.

### SUMMARY

The invention therefore addresses the object of providing an improved fastening element for a component, in particular for integration into a vehicle or a piece of furniture, an improved panel element with such a fastening element, an improved component with such a fastening element, an improved vehicle with such a panel element and/or component, and improved methods for producing a panel element and a component.

This object is achieved by the subject matter of the independent claims. Advantageous embodiments are specified in the dependent claims and the description.

According to a first aspect of the present invention, a fastening element is provided. The fastening element serves in particular to fasten a first panel element to a second panel element and/or to produce a component consisting of at least two panel elements. The panel element and/or the component consisting of at least two panel elements serves in particular for integration into a vehicle and/or a piece of furniture. In particular, the fastening element forms part of a piece of furniture which is integrated into a vehicle.

In this case, the fastening element according to the invention comprises a partially cylindrical body and a projection extending from the body in the radial direction. The fastening element also comprises at least one first spreading element which is configured to spread outwards radially from the body, and a fastening means guide which is configured to receive a fastening means therein and to guide it through a passage which is arranged in the body and is connected to the fastening means guide.

The fastening element can also be referred to as a connecting element, connector, in particular a cup connector and/or mounting element, and initially has a substantially cylindrical base body and a projection extending therefrom. In particular, the body has a partially circular cross-section and a projection extending radially away from the body on one side.

The projection itself may have a partially cylindrical cross-section or at least rounded edges. In particular, the body is designed to be more than 180°, more than 225°, more than 270°, or more than 315° cylindrical or with a circular cross-section, and the projection extends into the remaining part-accordingly less than 180°, less than 135°, less than 90°, or less than 45°. In this case, the projection or its extension in the radial direction is in particular less than a diameter or twice the radius of the cylindrical body, in particular less than a single radius.

The fastening element serves in particular to be received in a recess in a panel element, in particular a first of two panel elements, in order to fasten the first panel element to the second panel element.

In this case, the first and second panel elements can also each be referred to as panels, wall elements, walls, surfaces, and/or surface elements and are constructed in panel-like and/or surface-like manner, wherein each of the first and second panel elements has a greater extent in length and width than in height or thickness.

In this case, the first and the second panel elements typically have a core, at least one cover layer, and optionally a film layer arranged on the cover layer. In this case, the core, the cover layer, and optionally the film layer are each themselves again panel-shaped and/or flat and arranged on top of each other or against each other. In this case, however, the thicknesses of the core, the cover layer, and the film layer can differ from one another. In other words, the first and the second panel elements are each designed as a multi-layer panel element, which can also be referred to as a sandwich panel or in a sandwich construction.

In particular, the first and second panel elements have a central, inner core, wherein, on each side of the core, in particular on each surface side, a cover layer is first arranged, and, on each of these, an outer film layer.

The core preferably comprises hollow regions which are in particular designed in a cell-like manner. These cell-like hollow regions are arranged in particular along a main extension plane of the panel elements, i.e., in particular along the length and width, in a repetitive manner. In this case, the hollow regions can be limited by strut elements—for example, in the form of side walls. This creates a honeycomb structure. The panel elements are therefore preferably designed as a sandwich panel with a honeycomb core, wherein the honeycombs need not necessarily be hexagonal. Rather, it is possible that a wide variety of geometries for the cell region are formed along a plane running parallel to the main extension plane. Polygonal, e.g., hexagonal, rectangular or diamond-shaped, circular, or elliptical cross-sections are possible. In particular, the core can be open-celled, in particular on the side facing the respective cover layer. Alternatively, the core can also be made of foam material, e.g., styrofoam or foam.

In this case, the cover layer has a smaller thickness and height than the core, and is essentially continuous and solid. The film layer, in turn, has a smaller thickness and height than the cover layer and is essentially just as continuous and solid. The first and the second panel elements can therefore in particular be formed in five layers.

In particular, all the elements of the first and/or second panel element, i.e., the core, the first and second cover layers, and the first and second film layers, are formed from one or more plastics, in particular one or more recyclable plastic and/or reusable plastics, more particularly from one or more thermoplastics, or at least comprise these. In particular, individual or all elements of the first and/or second panel element are formed from polypropylene and/or comprise polypropylene. Alternatively or additionally, individual or all elements of the first and/or second panel element are formed from polyethylene and/or comprise polyethylene. Additionally or alternatively, the elements of the first and/or second panel element may comprise one or more other, in particular recyclable and/or reusable, materials that are not or do not comprise plastic, such as natural fibers like wood. In particular, the first and/or second cover layer may contain a fiber reinforcement. The fiber reinforcement can include, for example, glass fiber, plastic (e.g., aramid), carbon, or renewable materials such as wood, hemp, or flax.

The thickness and height of the panel elements are, for example, between 10mm and 30 mm, especially between 12 mm and 20 mm. The surface weight of the panel elements is, for example, between 100 g/m² and 10,000 g/m², especially between 1,000 g/m² and 8,000 g/m², more particularly between 700 g/m² and 5,000 g/m².

The film layer can act as a decorative layer. It is preferably made of plastic, e.g., polypropylene. The film layer for example has a thickness of 10 μm-80 μm, preferably 100 μm-500 μm.

In this case, a recess may be provided in at least one of the first and/or second panel elements. In this case, the recess can extend in particular through the first film layer and the cover layer, and at least partially into the core. In particular, the recess does not extend to the opposite side towards the second cover layer, but terminates inside the core. Preferably, the fastening element thus does not touch the opposite cover layer and also cannot leave any marks there.

In particular, the film layer and the cover layer are removed on one side-for example, by milling and/or cutting out. In this case, in particular a recess similar to and/or corresponding to the shape or outer contour of the fastening element can be provided. In particular, the recess has a similar or identical shape and/or a similar or identical diameter to the cylindrical body, at least in the first film layer and the cover layer. In particular, a so-called undercut can also be provided in the core, i.e., a larger outer contour than in the film layer and the cover layer. This can be achieved using a so-called T-cutter. This is particularly suitable for panel elements with a relatively soft core.

When the fastening element is received in the recess, anti-twist securing about a central axis of the fastening element is provided or ensured, in particular by means of mutually corresponding shapes and, furthermore, in particular by means of the projection, which provides an asymmetry compared to the remaining cylindrical body.

In order to ensure that the cylindrical body can also be displaced in the axial direction, one or more spreading elements are provided which are designed to extend radially away from the body or to spread away from it. For this purpose, the spreading element(s) can extend in particular into the core of the panel element and in particular engage therewith, when the fastening element is received in the recess. Likewise, in this case, the spreading element(s) may extend under the cover layer and/or the film layer and thus secure the fastening element against axial displacement. The function of one or more of these spreading elements will be explained in more detail later.

The fastening element also has a fastening means guide formed in the cylindrical body, which guide is configured to receive a fastening means therein and to guide it through a passage which is arranged in the body and is connected to the fastening means guide. This fastening means guide serves in particular to receive and guide the fastening means, such as a screw and/or a plug, e.g., with one or more latching elements and/or barbs, specifically through the fastening means guide and a passage connected thereto, radially outwards, out of the fastening element, in order to engage with the second panel element and in particular a corresponding fastening means receptacle arranged therein and to be fastened thereto—for example, by a threaded engagement and/or a latching mechanism. In particular, the fastening means receptacle can be designed as a dowel which has been arranged in or on the second panel element—for example, by a friction-welding process. The fastening means can in particular be a screw with a tool holder in the form of a hexagon socket or Allen key, which can be particularly suitably fastened with a tool in a corresponding form, a so-called Allen key. In particular, due to the arrangement of the fastening means guide, fastening with an Allen key with a ball head is particularly suitable and enables particularly secure fastening of the fastening means.

In particular, the fastening means guide and the passage are arranged and formed relative to one another and in the body in such a way that the fastening means is guided substantially or exactly perpendicularly to an axial direction of the cylindrical body and can thus be fastened substantially or exactly perpendicularly in a second panel element arranged perpendicularly to the first panel element. In particular, the fastening means guide has an angle of 90°+2° to an axial direction of the cylindrical body.

The fastening means guide can in particular be designed as a channel in the body, which extends substantially or exactly along a radial direction of the body at least from the center of the cylindrical body, in particular from within the projection through the center, to a wall, in particular a wall surface of the cylindrical body, and in particular opens into the passage. In this case, the channel can be substantially rectangular and/or semicircular in shape and extends from a cover surface to the interior of the cylindrical body and is open to a cover surface. In particular, the diameter and/or radius of the channel may taper towards the passage—for example, with one or more steps and/or linearly. In particular, the diameter and/or radius of the channel is greater than the diameter and/or radius of the passage, wherein it is possible for the passage to be formed in particular so as to be round, more particularly so as to be circular.

In this case, the fastening element or its components or elements can be formed at least partially or completely from a plastic, in particular from a thermoplastic, as described above. In particular, the material of the fastening element is an injection-moldable material, or the fastening element is at least partially manufactured using an injection-molding process, as will be described below.

The fastening element according to the invention makes it possible to connect and fasten two panel elements to one another using only one fastening element and a fastening means guided in the fastening element, as well as a receptacle corresponding to the fastening means. In particular, the fastening element according to the invention makes it possible to dispense with a second fastening element and/or a profile rail. The fastening element according to the invention and in particular the fastening means guide also ensures perpendicular and thus particularly precise guidance of a fastening means.

According to a development, the first spreading element is spring-mounted.

In particular, the spreading element is arranged to be movable against a spring tension. For example, the spreading element can spring back and forth between a first and a second position or be arranged so as to be movable therebetween. In particular, the spreading element is spring-mounted about an axis which extends substantially tangentially to the circumference of the cylindrical body or its wall surface, or parallel thereto.

This development ensures particularly easy insertion of the fastening element into the recess in the panel element.

According to a development, the first spreading element is pre-tensioned in a spread position.

For example, the spreading element can be moved from a first, spread position, in which it extends radially outwards away from the body, into a second, retracted position in which it extends less or not at all radially outwards away from the body, wherein a rest position, viz., in particular when no force acts upon the spreading element, in particular due to the spring action, is assumed by the spreading element in the first, spread position.

This development also ensures particularly easy insertion of the fastening element into the recess in the panel element. In particular, the pre-tension additionally provides a particularly secure fastening in the axial direction and prevents unintentional detachment of the fastening element from the recess.

According to a development, the first spreading element is arranged on the fastening element by an injection-molding process.

In this case, an injection-molding process, which can also be referred to as injection molding, is a manufacturing or primary molding process in which a liquefied plastic is injected into a mold, where the plastic hardens to its final shape. In particular, the first spreading element and/or all spreading elements are molded onto or around the fastening element, in particular the body.

This development enables a particularly simple and cost-effective arrangement or design of the spreading element(s).

According to a development, the first spreading element is integral with the body.

In this development, the first spreading element and/or all the spreading elements are integral with the body, i.e., formed in one piece and/or from the same material. In particular, the spreading element(s) have been manufactured in one work step-for example, by an injection-molding process. In particular, the projection and/or all other components of the fastening element described above and below, with the exception of the cover element described below, are made of one piece, material, and/or casting, and the fastening element as such or as a whole is made in one piece.

This development enables particularly simple and cost-effective production of the fastening element.

According to a development, the fastening element further comprises a second spreading element which is designed to spread outwards radially from the body, wherein the second spreading element is arranged at a distance from the first spreading element, in particular in the circumferential direction of the fastening element.

In this case, the second spreading element can be designed similarly or identically to the first spreading element, with the exception that it is arranged at a different position on the body. In particular, all configurations of the first spreading element described previously and/or below also apply to the second and further spreading elements.

It is understood that more than two spreading elements can also be provided—for example, three, four, or more than four spreading elements.

This development enables particularly secure fastening in the axial direction.

According to a development, the second spreading element is arranged radially opposite the first spreading element.

In particular, between the first and the second spreading elements, there is an angle of at least 90°, in particular at least 120°, more particularly between 175° and 205°, more particularly between 185° and 195°, more particularly essentially or exactly 180°. If more than two spreading elements are provided, the distance between the spreading elements can be substantially or exactly 360° divided by the number of spreading elements provided-for example, with three spreading elements, 120°, with four spreading elements, for example, 90°, etc.

This development also enables particularly secure fastening in the axial direction.

According to a development, the fastening element further comprises a capture element which is designed to receive a fastening means moving out of the passage counter to a passage direction.

In this case, the capture element is arranged in particular in the projection and/or the channel or the fastening means guide, and represents in particular the end point or the end of the same. In particular, the capture element has a wall whose plane is arranged perpendicularly to the passage direction. In particular, the capture element also has a recess or hollow in which the fastening means can be at least partially received.

This development makes it possible to safely catch a fastening means that accidentally falls out of the passage during the fastening process, particularly due to gravity, and thus to prevent loss.

According to a development, the capture element is arranged radially opposite the passage.

In particular, the capture element is arranged opposite to the passage direction, which runs substantially radially, as previously described.

This development enables particularly reliable reception of the fastening means.

According to a development, the fastening element further comprises a cover element which is designed to be detachably fastened to the body and which covers the fastening means guide in the fastened state.

In particular, the cover element is designed such that it covers the entire body and in particular also the projection in the fastened state. Also in particular, the cover element has a shape and/or external dimensions that are substantially equal to or larger than those of the body and/or the projection.

In particular, the cover element projects beyond the body and/or the projection in the radial direction-for example, by 1 mm, 2 mm, 5 mm, or 10 mm. In particular, the overhang extends essentially as far as the spreading element or the spreading elements protrude from the body, or further.

In particular, the cover element rests on the film layer of the panel element in the fastened state when the fastening element is received in the recess of the panel element, in particular around the part which projects beyond the body and/or projection.

This development ensures a particularly aesthetic arrangement and use of the fastening element. The overhang provides additional movement protection in the axial direction.

According to a development, the cover element has at least one lid projection, and the body has at least one lid receptacle corresponding to the lid projection, wherein the lid projection, when it is received in the lid receptacle, is designed to fasten the lid to the body.

For this purpose, the at least one lid projection can have, for example, a latching element and/or an engagement element, and the at least one lid receptacle can have a corresponding receptacle, so that, when the lid is guided onto the body and the at least one lid projection is received in the at least one lid receptacle, a latching and/or engagement of the cover element on the body is created, and these are fastened to one another, in particular detachably.

This development results in a particularly secure fastening of the cover element to the body.

According to a development, the lid projection, when received in the lid receptacle, causes at least one spreading element to spread.

For this purpose, the at least one lid receptacle is formed near or on at least one spreading element in the body. In particular, the lid receptacle has a recess in the body which projects onto the spreading element and, when the lid projection is received therein, in particular by one or more latching and/or engagement elements on the lid projection, spreads the spreading element outwards from the first, retracted position, in particular against the spring force or pre-tension of the spreading element, into the second, spread position. In particular, the lid projection accommodated in the lid receptacle prevents or blocks a movement of the spreading element back to the first position.

In particular, one, in particular exactly one, lid receptacle and one, in particular exactly one, lid projection are provided for each spreading element.

This development enables particularly simple and at the same time reliable spreading and thus fastening of the body in the panel element. In particular, this results in a particularly high tensile strength of the fastening element in the panel element of over 500 Nm, especially over 600 Nm, in a direction axial to the body.

According to a further aspect, a panel element is specified.

The panel element comprises a fastening element according to one or more of the previously described embodiments, wherein the panel element has a recess in which the fastening element is received.

The panel element may in particular be the first panel element described above or below and may have the properties thereof.

In particular, the fastening element is received in the recess in such a way that the spreading element(s) extend into the core of the panel element and prevent detachment from the recess, in particular in the axial direction of the body.

According to a further aspect, a component is specified.

In this case, the component comprises a first panel element, a second panel element, and a fastening element according to one or more of the previously described embodiments, wherein the fastening element fastens the first panel element and the second panel element to one another.

In this case, the first panel element can in particular be the panel element described above. The fastening element can, when received in the first panel element and fastened therein by the spreading element(s), be received on a fastening means receptacle, which is arranged in the second panel element, with the aid of a fastening means which is guided through the fastening means guide and the passage, and thus fasten the two panel elements to one another. In this case, the first panel element and the second panel element are in particular arranged substantially or exactly perpendicularly to one another. Alternatively, however, the first panel element and the second panel element can also be arranged at an angle to each other, in particular a predetermined angle, e.g., smaller or larger than 90°—for example, between 15° and 75°, between 30° and 60°, or substantially or exactly 45° and/or between 105° and 165°, between 120° and 150°, or substantially or exactly 135°. This can be done in particular by a fastening means in the form of a bolt, in particular with one or more projections or claws, which engage in particular in the core of the panel element.

According to a further aspect, a vehicle is specified comprising a panel element according to one or more of the previously described embodiments and/or a component according to one or more of the previously described embodiments.

In particular, the vehicle comprises one or more pieces of furniture which comprise and/or are formed from at least one or more such panel elements and/or components. The vehicle can in particular be a recreational vehicle (RV for short), which can also be referred to as a camper or mobile home.

In this case, such a recreational vehicle comprises in particular a living area in which one or more such components, in particular one or more pieces of furniture with one or more such components, are arranged or present. Such a recreational vehicle also preferably has a drive, e.g., an internal combustion engine and/or an electric drive, with which it can move independently.

Alternatively, the vehicle is a trailer, in particular a camping trailer, which may also be referred to as a camper, and which comprises such a component and/or a piece of furniture with such a component. Such a trailer may also include a living area as described above, but is typically not designed to move independently, but is usually pulled by a towing vehicle.

Likewise, alternatively or additionally, the vehicle is a watercraft, such as a ship and/or boat.

According to a further aspect, a method for producing a panel element is specified.

In this case, the method according to the invention comprises the steps of providing a panel element, arranging a recess in the panel element, arranging a fastening element according to one or more of the previously described embodiments in the recess.

According to a further aspect, a method for producing a component is specified.

In this case, the method comprises the steps of providing a first panel element, providing a second panel element, arranging a recess in the first panel element, arranging a fastening element according to one or more of the previously described embodiments in the recess, arranging the first panel element on the second panel element, and fastening the first panel element to the second panel element using the fastening element.

According to a further aspect, a panel element is specified, in particular a panel element according to one or more of the previously described embodiments, which was produced by a previously described method for producing a panel element.

According to a further aspect, a component is specified, in particular a panel element according to one or more of the previously described embodiments, which was produced by a previously described method for producing a component.

With regard to the embodiments and/or developments of the panel element, component, vehicle, and the method according to the invention and their advantages, reference is additionally made to the previously described embodiments and/or developments of the fastening element according to the invention and their advantages.

The invention makes it possible to connect and fasten two panel elements to one another using only one fastening element and a fastening means guided in the fastening element, as well as a receptacle corresponding to the fastening means. In particular, the fastening element according to the invention makes it possible to dispense with a second fastening element and/or a profile rail. The fastening element according to the invention and in particular the fastening means guide also ensures perpendicular and thus particularly precise guidance of a fastening means.

### BRIEF DESCRIPTION OF THE DRAWINGS

The invention is now explained in more detail on the basis of exemplary embodiments with reference to the accompanying drawings. Identical or corresponding parts are identified by the same reference signs in the drawings.

In the drawings:

FIG. 1 is a schematic perspectival view of a fastening element according to an embodiment of the invention;

FIG. 2 is a lateral sectional view of a fastening element in the installed state in a panel element to a component according to an embodiment of the invention.

### DETAILED DESCRIPTION

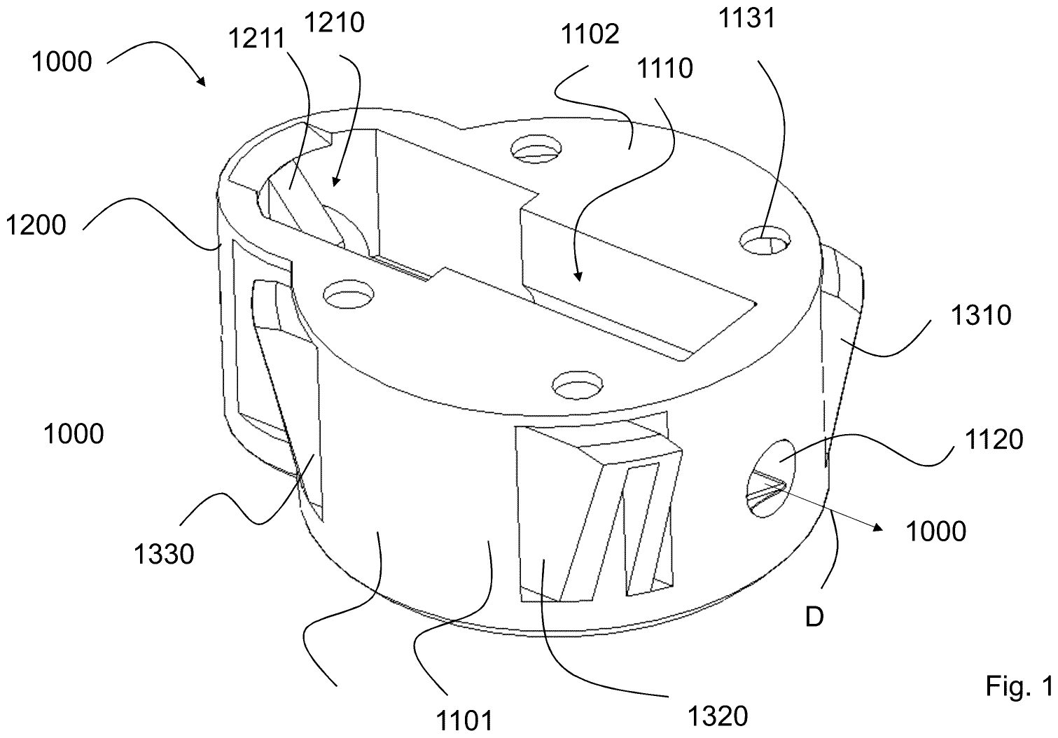

FIG. 1 is a schematic perspectival view of a fastening element 1000 according to one embodiment of the invention.

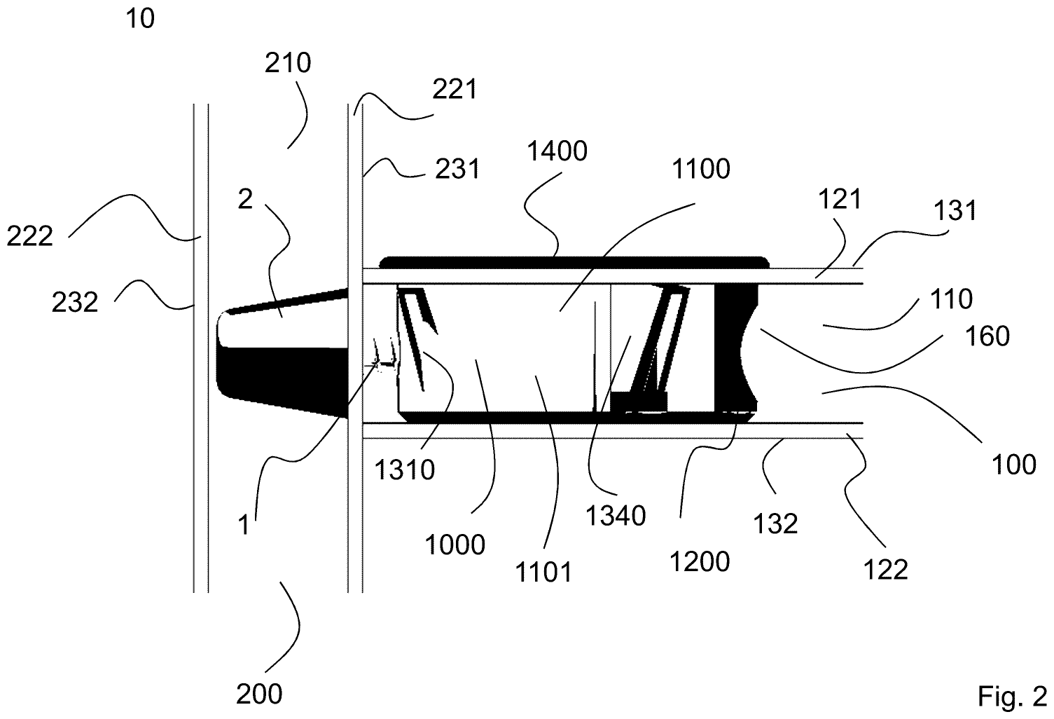

The fastening element 1000 is used to produce a component from two panel elements, as will be explained in detail below in connection with FIG. 2.

The fastening element 1000 comprises a partially cylindrical body 1100 and a projection 1200 extending from the body 1100 in the radial direction. In this case, the body has a surrounding wall surface 1101 and an upper and a lower cover surface, of which only the upper cover surface 1102 is visible due to the perspectival view.

A total of four spreading elements are provided in the body 1100, of which only the first three spreading elements 1310, 1320, 1330 are visible due to the perspectival view, and which each extend radially and perpendicularly away from the wall surface 1101. In this case, the four spreading elements are each offset by 90° along the circumference of the body, wherein in each case two spreading elements radially oppose each other.

In this case, the four spreading elements are each spring-mounted and pre-tensioned in the position shown here in FIG. 1, wherein it is possible for the spreading elements to be pushed completely into the body against the pre-tension by the application of force when they are inserted into a recess of a panel element (not shown here). In particular, the spring-mounting at the lower end, opposite to the upper cover surface 1102 along an axis which in each case extends tangentially to the circumference of the cylindrical body 1100, enables particularly good and easy insertion into the recess.

The fastening element 1000 also has a fastening means guide 1110 which is formed in the body 1100 and is designed to receive therein a fastening means (not shown here) and to guide this through a passage 1120, which is arranged in the body 1100 and is connected to the fastening means guide 1100, in a passage direction D which runs radially.

The fastening element 1000 also has a capture element 1210 which is arranged radially opposite to the passage 1120 and which is designed to receive a fastening means 1 moving out of the passage 1120 against the passage direction D. For this purpose, the capture element 1210 in particular has a catch wall 1211.

In this case, a total of four lid receptacles are formed in the body 1100, of which only one lid receptacle 1131 is provided with a reference sign, and which are arranged in the upper cover surface 1102 at the respective position of the spreading element. The lid receptacles are designed to receive a cover element (not shown here) and to releasably fasten it thereto, as will be explained in more detail below in connection with FIG. 2.

In this case, all the elements or components of the fastening element 1000 shown here in said FIG. 1 are formed integrally with each other and are manufactured in particular by an injection-molding process.

FIG. 2 is a lateral sectional view of a fastening element 1000 in the installed state in a panel element 100 for forming a component 10.

In this case, the fastening element 1000 is, as shown in FIG. 1, received in a recess 160 in a first panel element 100 and fastened therein. As shown here in said FIG. 2, the fastening element 1000 fastens the first panel element 100 on the second panel element 200 using a fastening means 1, which is shown here by way of example as a screw, and which is shown in a fastening means holder 2, also shown by way of example as a friction welding anchor, and fastened to it. In this case, the fastening means 1 is guided through the fastening means receptacle shown in detail in FIG. 1 and is thus guided vertically onto the fastening means receptacle 2.

The component 10 formed or fastened by the fastening element 1000 is used in particular for integration into a vehicle or piece of furniture and comprises a first panel element 100, which has a core 110, a top layer 121, 122 on each side of the core 110, and a film layer 131, 132 arranged on the respective cover layer 121, 122. The component also comprises a second panel element 200 which has a core 210, a cover layer 221, 222 on each side of the core, and a film layer 231, 232 arranged on the respective cover layer 221, 222. In this case, the respective cores 110, 210 have the greatest extent along the thickness and are essentially the same thickness, the respective cover layers 121, 122, 221, 222 have a smaller extent along the thickness and are essentially the same thickness, and the film layers 131, 132, 231, 232 have an even smaller extent along the thickness and are also essentially the same thickness.

In this case, the first panel element 100 and the second panel element 200 are essentially constructed identically and each comprise a total of five layers, which can also be referred to as sandwich panels. In this case, each of the two panel elements 100, 200 can be described as panel-shaped and has a greater extent along the width and length than along the thickness, which can also be referred to as the height. In this case, the panel elements each have a main extension plane that extends in the direction of length and width. The respective opposite surfaces, which extend along the length and width, can also be called surface sides, whereas the other four sides, two of which are also opposite each other and which extend along the length and thickness or along the width and thickness, can also be called end faces. In this case, the first panel element 100 is arranged with its end face perpendicular to a surface side of the second panel element 200.

In this case, in order to create the recess 160, the film layer 131 and the cover layer 121 and the majority of the core 110 apart from the opposite cover layer 122 have been removed, in particular milled-for example, by a T-cutter. In particular, the fastening element 1000 is dimensioned in such a way that it has a height which is essentially or exactly as large as the core plus a cover layer 121 and a film layer 131, with the exception of the cover element 1400, which is described below.

In this case, said FIG. 2 also shows the first spreading element 1310, as shown in FIG. 1, and a fourth spreading element 1340. In this case, the spreading elements extend radially away from the body 1100 in such a way that they spread into the core 110 after insertion into the recess 160, and in this spread state strike or engage with one surface on a bottom or inside of the cover layer 121 and thus prevent an axial displacement of the fastening element 1000 upwards.

Said FIG. 2 also shows the cover element 1400, which is received in the lid receptacles shown in FIG. 1 and is fastened therein, and which covers the fastening means guide or the entire fastening element 1000 on the upper lid surface. In this case, the cover element protrudes beyond the outer dimensions of the body 1100 and the projection, and lies on top of the film layer 131.

In this case, in particular the lid projections have a latching element which engages with a corresponding receptacle in the respective lid receptacle in the received state. By receiving the lid projections in the respective lid receptacle, in particular a spreading of the respective spreading elements on which the lid receptacles are arranged is effected.

1. A fastening element for a component, wherein the component is suitable for integration into a vehicle or a piece of furniture, wherein the fastening element comprises:
a partially cylindrical body;
a projection extending from the partially cylindrical body in the radial direction;
at least one first spreading element which is designed to spread outwards radially from the partially cylindrical body; and
a fastening means guide which is formed in the partially cylindrical body and is designed to receive a fastening means therein and guide it through a passage which is arranged in the partially cylindrical body and is connected to the fastening means guide.

2. The fastening element according to claim 1, wherein the at least one first spreading element is spring-mounted.

3. The fastening element according to claim 1, wherein the at least one first spreading element is pre-tensioned in a spread position.

4. The fastening element according to claim 1, wherein the at least one first spreading element is arranged on the fastening element by an injection-molding process.

5. The fastening element according to claim 1, wherein the at least one first spreading element is integral with the partially cylindrical body.

6. The fastening element according to claim 1, further comprising:
a second spreading element, which is designed to spread outwards radially from the partially cylindrical body;
wherein the second spreading element is arranged at a distance from the at least one first spreading element.

7. The fastening element according to claim 6, wherein the second spreading element is arranged radially opposite the at least one first spreading element.

8. The fastening element according to claim 1, further comprising:
a capture element which is designed to receive the fastening means moving out of the passage counter to a passage direction.

9. The fastening element according to claim 8, wherein the capture element is arranged radially opposite to the passage.

10. The fastening element according to claim 1, further comprising a cover element which is designed to be detachably fastened to the partially cylindrical body and which covers the fastening means guide in the fastened state.

11. The fastening element according to claim 10, wherein the cover element has at least one lid projection, and the body has at least one lid receptacle corresponding to the at least one lid projection, wherein the at least one lid projection when received in the at least one lid receptacle, is designed to fasten the lid to the body.

12. The fastening element according to claim 11, wherein when the at least one lid projection is received in the at least one lid receptacle, brings about a spreading of the at least one spreading element.

13-14. (canceled)

15. A vehicle comprising a panel element, the panel element comprising a fastening element, the fastening element comprises:
a partially cylindrical body;
a projection extending from the partially cylindrical body in the radial direction;
at least one first spreading element which is designed to spread outwards radially from the partially cylindrical body; and
a fastening means guide which is formed in the partially cylindrical body and is designed to receive a fastening means therein and guide it through a passage which is arranged in the partially cylindrical body and is connected to the fastening means guide, wherein the panel element has a recess in which the fastening element is received and/or a component comprising a first panel element, a second panel element, and a fastening element, wherein the fastening element fastens the first panel element and the second panel element to one another.

16. (canceled)

17. A method for producing a component, comprising:
providing a first panel element;
providing a second panel element;
arranging a recess in the first panel element;
arranging a fastening element in the recess, the fastening element comprising:
a partially cylindrical body;
a projection extending from the partially cylindrical body in the radial direction;
at least one first spreading element which is designed to spread outwards radially from the partially cylindrical body; and
a fastening means guide which is formed in the partially cylindrical body and is designed to receive a fastening means therein and guide it through a passage which is arranged in the partially cylindrical body and is connected to the fastening means guide;
arranging the first panel element on the second panel element; and
fastening the first panel element on the second panel element using the fastening element.

18-19. (canceled)
